(19) United States
(12) Patent Application Publication
(10) Pub. No.: US 2010/0206436 A1
(43) Pub. Date: Aug. 19, 2010

(54) Method and Apparatus for Turning a Log for Processing in a Sawmill

(76) Inventor: Henry L. Cordell, Frankfort, MI (US)

Correspondence Address: VAN OPHEM & VANOPHEM, PC;REMY J VANOPHEM, PC, 51543 VAN DYKE, SHELBY TOWNSHIP, MI, 48316-4447, US

(21) Appl. No.: 12/371,960

(22) Filed: Feb. 17, 2009

(51) Int. Cl. B27B 1/00; B27B 31/00

(52) U.S. Cl. 144/357; 144/250.24

(57) ABSTRACT

A log on a surface of a translatable carriage against head blocks of the carriage is turned by rolling the log on the surface of the translatable carriage after releasing the log from engagement by reciprocating dogs that are carried by the head blocks and before advancing the translatable carriage toward a saw. The turning of the log on the surface is accomplished by engaging the log by a reciprocating dog that is carried by a pivoting arm at a location away from the engagement of the log by the reciprocating dogs that are carried by the head blocks. After turning of the log on the surface of the translatable carriage, the log is pushed along the surface of the translatable carriage back toward the head blocks by pushing against the log by spaced-apart double-acting cylinders that are mounted on non-translatable stands respectively.

### CROSS-REFERENCES TO RELATED APPLICATIONS

Not applicable.

### FEDERALLY SPONSORED RESEARCH OR DEVELOPMENT

Not applicable.

### REFERENCE TO SEQUENCE LISTING

Not applicable.

### BACKGROUND OF THE INVENTION

1. Field of the Invention

This invention relates in general to an apparatus and a method for turning a log about its longitudinal central axis at a fixed location in preparation for advancing the log on a reciprocating carriage to have a portion of the log removed by a saw in a sawmill. More specifically, the invention is used to turn a log 90 degrees “face down” after each return of the carriage carrying the log in a sawmill operation.

2. Description of Related Art

U.S. Pat. No. 5,950,517 (Yoder) discloses a log turner for turning a log about its longitudinal central axis. The log turner of this reference travels with the sawmill carriage, which adds to the complexity of the apparatus and increases its energy consumption relative to a log turner that is capable of performing its intended function at a fixed location. U.S. Pat. No. 5,622,213 (McKelvie) also discloses a log turner for turning a log about its longitudinal central axis for delivery to an outfeed conveyor. The apparatus of this reference requires a rotatable housing that surrounds the log and turns in pre-selected increments to turn the log about its longitudinal central axis. This apparatus is quite complex, requiring as it does a rotational drive motor that operates a speed reducer through a pulley and belt drive. U.S. Pat. No. 5,765,617 (Mierau et al.) discloses a log-orienting apparatus that orients a log for entry into a processing unit. This apparatus is capable of orienting the log to change the orientation of its longitudinal central axis, as is shown in FIGS. 6A-6D, and this is a degree of complexity, and expense, that is not required in a typical sawmill operation.

What is needed is an inexpensive log positioning apparatus that positively remains in contact with the log so as to provide continuous control of the log as the log is turned 90 degrees “face down” after each return trip of the saw and pushed into the carriage blocks to secure the log into the carriage before each cut of the saw.

### BRIEF SUMMARY OF THE INVENTION

According to the present invention, there is provided a method and an apparatus for turning a log in increments about its longitudinal central axis for processing of the log on a reciprocating carriage toward and away from a sawing station, for example, a rotary saw, for removal of slab-like portions of the log. At the conclusion of the sawing step, the log-bearing carriage is returned to its start position, whereupon the apparatus of the present invention engages the log to turn the log about its longitudinal central axis, for example, in 90 degree increments, for the next sawing operation.

The log turner of the present invention has spaced apart upright stands, each of which has a double acting hydraulic cylinder, to push the log against a moveable headblock that is positioned on a reciprocating carriage which transports the log through the sawing station. When mounted on the carriage against the headblocks, vertical reciprocating means mounted on the reciprocating carriage, such as hydraulic driven dogs, engage the log as it is moved into position against the headblocks to maintain it in position during its transfer to and from as well as through the sawing operation. The log turning apparatus of the present invention also has a pivoting or tilting arm positioned between the spaced apart upright stands. The tilting arm, which does not reciprocate with the log-carrying carriage, oscillates between a substantially horizontal rest position and a substantially vertical log-engaging position, and has a reciprocating member hydraulically activated, such as a dog that engages the log on the reciprocating carriage. When the tilting arm tilts from a vertical position towards its horizontal position, the dog causes the log to move in a direction away from the carriage headblocks and at the same time roll about its central axis to permit a now flat portion of the log to turn with the log turner. A hydraulically activated pusher arm contacts the log at its lowest point while under contact with the dog on the log turner until the log has completed its turn in a pre-selected part-turn, for example, 90 degrees. At this time, the pusher arms on the fixed upright stands of the apparatus are advanced further against the log, now on its previously cut side, to push it back against the carriage headblocks. The movable headblocks then advances the log a predetermined distance in a direction lateral to the reciprocating carriage whereafter it is hydraulically fixed by the PLC controls of the machine where after the log is again engaged by the hydraulically-driven dogs on the carriage in preparation for other processing steps. The tilting arm of the log turning apparatus is then oscillated back to a rest position to await the start of another log turning cycle which is repeated as described above after a second cut is made by the saw.

### BRIEF DESCRIPTION OF SEVERAL VIEWS OF THE DRAWINGS

FIG. 1 is a perspective view showing the apparatus according to a preferred embodiment of the present invention for practicing a method according to the present invention;

FIG. 2 is a side elevation view of a portion of the apparatus of FIG. 1 with the dog of the tilting arm engaging the log at the start of the log turning operation during the practice of the method of the present invention;

FIG. 3 is a view like FIG. 2 showing the apparatus in another position of its log turning operation;

FIG. 4 is a view like FIGS. 2 and 3 showing the apparatus with the pusher arms engaging the log to assist in turning of the log onto its first cut flat surface to engage the carriage; and

FIG. 5 is a view like FIGS. 2, 3 and 4 showing the apparatus with the log in final position clamped by the carriage headblocks for the next step of its operation.

### DETAILED DESCRIPTION OF THE PREFERRED EMBODIMENT

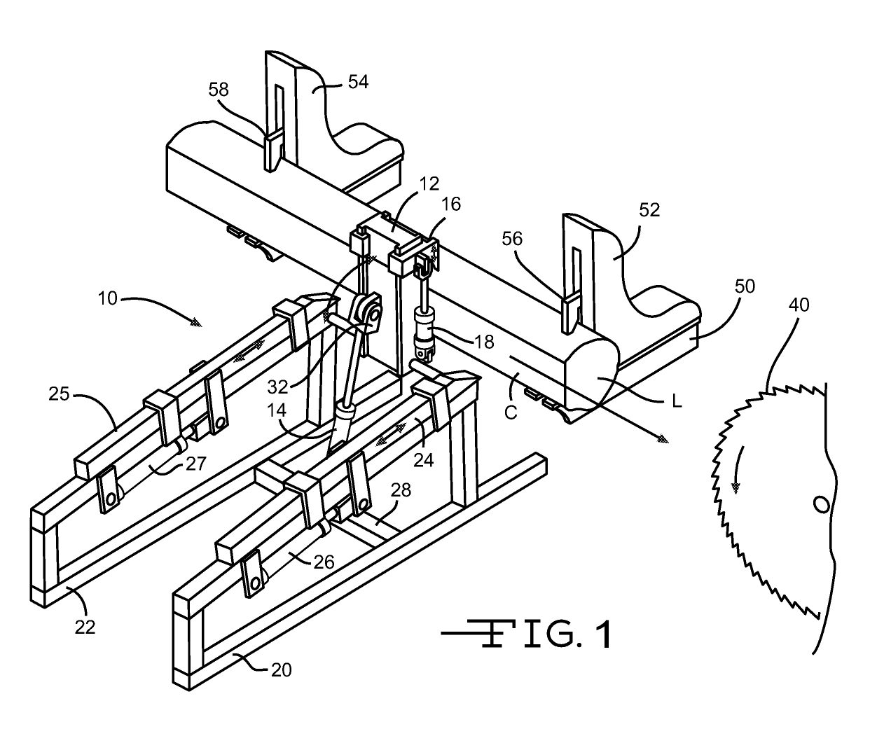

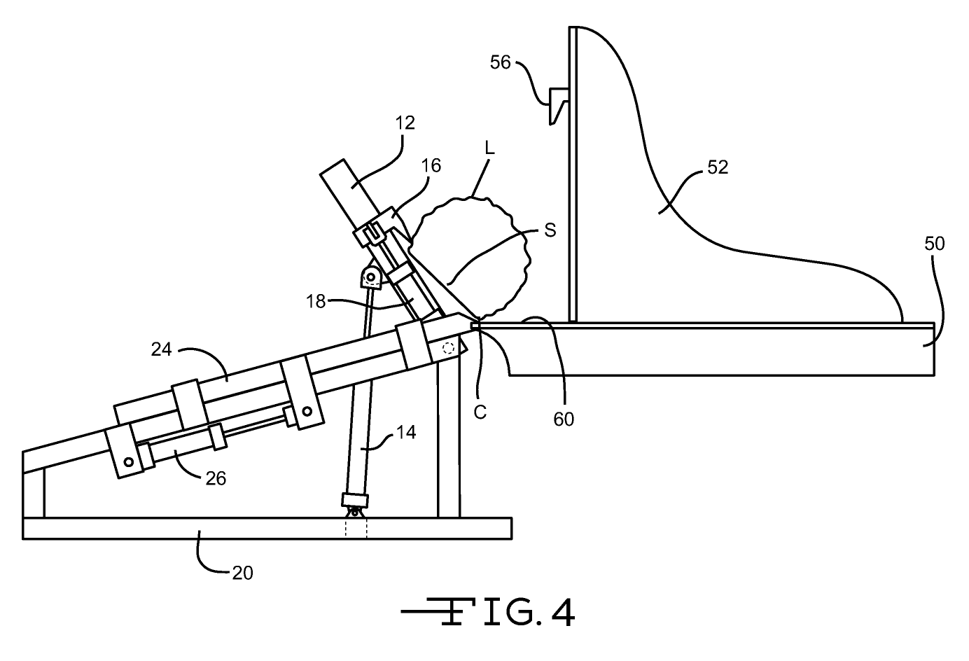

With reference to FIGS. 1-5, a log turner apparatus according to a preferred embodiment of the present invention is indicated generally by reference numeral 10 in the drawings. The log turner apparatus 10 is used to turn a log L to be carried to a saw 40 by a reciprocating carriage 50, which is conventional in the prior art. The reciprocating carriage 50 has a spaced-apart pair of movable headblocks 52, 54 that reciprocate with the reciprocating carriage 50 as well as are hydraulically movable lateral to the reciprocating carriage 50. The movable headblocks 52, 54 have vertically reciprocating dogs 56, 58, respectively, that secure the log L on the reciprocating carriage 50 as the reciprocating carriage 50 advances toward and away from the saw 40.

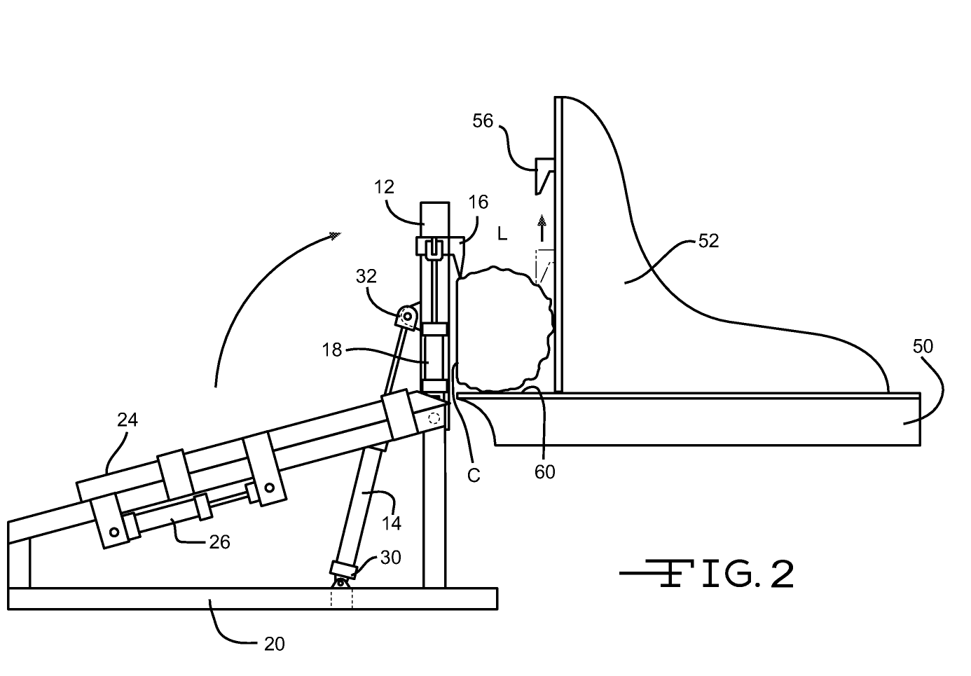

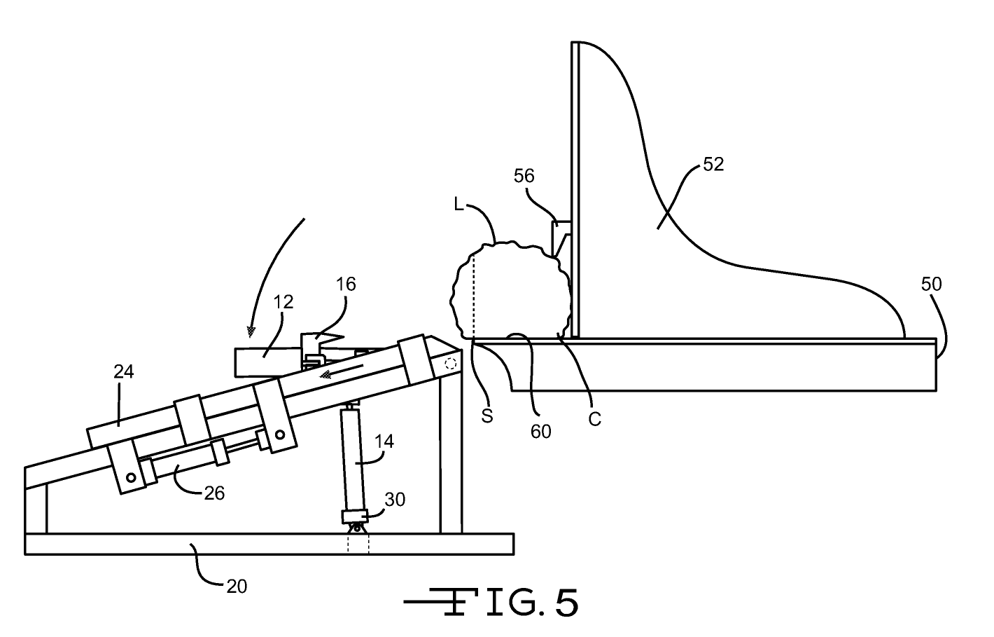

The log turner apparatus 10, which does not reciprocate with the reciprocating carriage 50, is located along side the reciprocating carriage 50 and has a tilting arm 12, mounted between upright stands 20, 22 pivotally oscillating between an upright substantially vertical position, as shown in FIG. 2 and a substantially horizontal position, as shown in FIG. 5. The tilting is accomplished with a double-acting hydraulic cylinder 14.

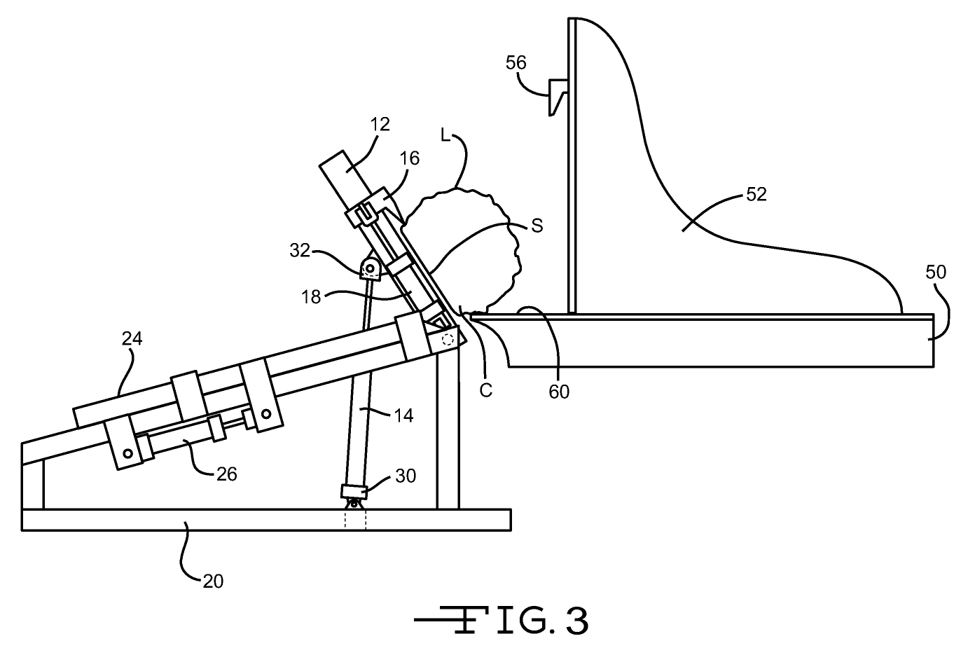

The double-acting hydraulic cylinder 14 has a cylinder end 30 that is pivotally connected to a base connecting member 28, which extends between the upright stands 20, 22, and a rod end 32 that is pivotally connected to the tilting arm 12. The tilting arm 12 has a reciprocating dog 16 that reciprocates along the central axis of the tilting arm 12, and is powered by a double-acting hydraulic cylinder 18. The reciprocating dog 16 engages the log L after the first cut is made with the saw 40 and the log L is reciprocated to its initial start position as shown in FIG. 2. The reciprocating dog 16 retracts the log L from the movable headblocks 52, 54, as shown in FIG. 2. After the reciprocating dog 16 clamps the log L, the tilting arm 12 is actuated to tilt in a direction away from the movable headblocks 52, 54 to begin rolling the log L towards the tilting arm 12 as illustrated in FIG. 3. The log L is then drawn toward spaced-apart upright stands 20, 22 until a corner C of the log L engages a flat surface 60 of the reciprocating carriage 50, at which time the log L begins to turn about its longitudinal central axis partially—as a result of gravity acting on the log L as well as under the influence of the force created by the double-acting hydraulic cylinder 18 and associated reciprocating dog 16 which continues to create a downward force on the log L. Pusher arms 24, 25 on the spaced-apart upright stands 20, 22 respectively, are advanced by hydraulic cylinders 26, 27 to engage the log L at spaced-apart locations to advance the log L and assist in pushing the corner C of the log L onto the flat surface 60 of the reciprocating carriage 50 so that as the tilting arm 12 continues to pivot the flat surface S of the log L will rest on the flat surface 60 of the reciprocating carriage 50 against the movable headblocks 52, 54 to prepare for another cutting cycle as shown in FIG. 5. As the log L turns on its flat surface S and in contact with the flat surface 60 of the reciprocating carriage 50, the pusher arms 24, 25 force the log L to locate against the movable headblocks 52, 54. The pair of movable headblocks 52, 54 are then hydraulically moved towards the log turning apparatus 10 in order to set the size of the cut to be made from the log L. Thereafter, the vertical dogs 56, 58 mounted on the reciprocating carriage 50 are actuated to clamp the log L in place against the movable headblocks 52, 54, now fixed in place, on the reciprocating carriage 50 for the next cut of the saw 40 to create a second flat surface (not shown). During this phase, the pusher arm hydraulic cylinders 26, 27 retract the pusher arms 24, 25 to the original start position while the tilting arm 12 is retracted to a position slightly tilted from the upright position so that it does not interfere with the log L or reciprocating carriage 50 for the next cut. The cycle disclosed above is then repeated to saw the third and fourth 90 degree flat surfaces on the log L which completes the log trimming operation.

It is also contemplated that a reversible rotary prime mover such as an electric motor, either directly connected by operating through a sprocket and chain drive, or a pulley and belt drive, can be substituted for the double-acting hydraulic cylinder 14.

Although the best mode contemplated by the inventor(s) for carrying out the present invention as of the filing date hereof has been shown and described herein, it will be apparent to those skilled in the art that suitable modifications, variations and equivalents may be made without departing from the scope of the invention, such scope being limited solely by the terms of the following claims and legal equivalents thereof.

What is claimed is:

1. Apparatus for turning a log on a surface of a translatable carriage for carrying said log toward a saw, after disengagement of said log by means associated with said translatable carriage for holding said log against said surface, said translatable carriage having at least one head block against which said log is positioned, said apparatus comprising:
spaced-apart, non-translatable stands positioned near said translatable carriage when said translatable carriage is positioned away from said saw;
a non-translatable arm that is pivotable in a vertical plane between a substantially vertical position and substantially horizontal position;
a reciprocating dog positioned on the non-translatable arm and moveable along said non-translatable arm between a first position in said substantially vertical position of said non-translatable arm, where it is adapted to engage said log on said surface of said translatable carriage, and a second position that is substantially away from said log when said non-translatable arm is in said substantially horizontal position, the engagement of said log by said reciprocating dog being effective to turn said log on said surface of said translatable carriage when said non-translatable arm is pivoted toward it's said substantially horizontal position; and
means carried by the first and second said spaced-apart non-translatable stands for advancing said log against said at least one head block of said translatable carriage after turning of said log on said surface of said translatable carriage.

2. Apparatus according to claim 1 further comprising:
means for pivoting said non-translatable arm to a vertical plane.

3. Apparatus according to claim 2 wherein said apparatus further comprises:
a connection between said first and second spaced-apart, non-translatable stands; and
said means for pivoting comprises a double-acting cylinder, a rod end of which is pivotably connected to said non-translatable arm, a cylinder end of which is pivotably connected to said connection between said first and second spaced-apart non-translatable stands.

4. Apparatus according to claim 1 wherein:
said means carried by said first and second spaced-apart non-translatable stands comprises a double-acting cylinder on each of said first and second spaced-apart non-translatable stands, respectively, for engaging said log at spaced apart locations on said surface of said translatable carriage.

5. A method of turning a log on a surface of a translatable carriage when said log is positioned against a head block of said translatable carriage while said translatable carriage is positioned away from a saw in a sawmill and before advancing said translatable carriage toward the saw, the method comprising the steps of:
releasing said log from engagement with said head block;
engaging said log at a location away from said engagement of said log against said head block;
turning said log on said surface of said translatable carriage by rolling said log away from said head block; then
advancing said log, after turning, back toward said head block.

6. The method according to claim 5 wherein:
turning the log on the surface of the translatable carriage is accomplished by pivoting said engagement of said log at the location of said log on said surface of said translatable carriage away from said location of said log against said head block.

7. The method according to claim 6 wherein:
the advancing of the log, after turning, back toward the head block is accomplished by simultaneously pushing said log at a plurality of spaced-apart locations toward said head block.

8. The method according to claim 7 wherein:
the pushing of the log back toward the head block is accomplished by extending a plurality of double-acting pushers.
